(19) United States
(12) Patent Application Publication
(10) Pub. No.: US 2015/0039751 A1
(43) Pub. Date: Feb. 5, 2015

(54) DYNAMIC PARALLEL COORDINATES VISUALIZATION OF NETWORK FLOWS

(71) Applicant: PacketSled Inc., Del Mar, CA (US)

(72) Inventors: Matthew G. Harrigan, Del Mar, CA (US); Kurt Neumann, Del Mar, CA (US)

(73) Assignee: PacketSled Inc., Del Mar, CA (US)

(21) Appl. No.: 13/957,740

(22) Filed: Aug. 2, 2013

(51) Int. Cl. H04L 12/26

(52) U.S. Cl. CPC H04L 43/045
USPC 709/224

(57) ABSTRACT

Methods and systems for providing dynamic parallel coordinates visualization of network flows are described. One example method includes identifying protocol metadata associated with a plurality of network flows on a network; analyzing the protocol metadata associated with the network flows to determine one or more metadata attributes associated with the network flows; and presenting a parallel coordinates visualization of the network flows, the parallel coordinates visualization including a plurality of axes, each axis corresponding to one of the determined metadata attributes, wherein each of the network flows is represented as a line interconnecting respective points on each of the axes of the parallel coordinates visualization, and wherein a position of each point on its respective axis represents a value of the metadata attribute associated with the axis for the network flow represented by the line.

### FIELD

This specification generally relates to dynamic parallel coordinates visualization of network flows.

### BACKGROUND

In enterprise and other computer networks, computers connected to an internal network may send data to destinations connected to wider, public networks such as the Internet. A network administrator, charged with overseeing the maintenance and security of a computer network, typically will monitor network traffic, either inbound or outbound or both, looking for undesirable or otherwise objectionable communications activity.

### SUMMARY

In general, one aspect of the subject matter described in this specification may be embodied in systems and methods performed by data processing apparatuses that include the actions of identifying protocol metadata associated with a plurality of network flows on a network, analyzing the protocol metadata associated with the network flows to determine one or more metadata attributes associated with the network flows, and presenting a parallel coordinates visualization of the network flows, the parallel coordinates visualization including a plurality of axes, each axis corresponding to one of the determined metadata attributes, wherein each of the network flows is represented as a line interconnecting respective points on each of the axes of the parallel coordinates visualization, and wherein a position of each point on its respective axis represents a value of the metadata attribute associated with the axis for the network flow represented by the line.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a diagram of an example environment for enabling dynamic parallel coordinates visualization of network flows.

FIG. 2 is an example interface showing a parallel coordinates visualization of a plurality of network flows.

FIG. 3 is an example interface showing a parallel coordinates visualization of a plurality of network flows including additional protocol-specific axes.

FIG. 4 is a flowchart of an example method for enabling dynamic parallel coordinates visualization of network flows.

FIG. 5 is a diagram of computing devices that may be used to implement the systems and methods described in this document.

Like reference numbers and designations in the various drawings indicate like elements.

### DETAILED DESCRIPTION

In general, network owners desire to understand and, to the extent possible, control information sent over their networks. For example, a network owner may desire to obtain an overall view of traffic currently running on a network, so as to identify potential network problems. Presenting such a view can be challenging for networks having a large amount of traffic, as presenting the data in an easily digestible visual manner is difficult. In addition, presenting the data in a static format that does not dynamically update to display different types of traffic differently may not be useful.

In some implementations, the present solution may present a network owner with a parallel coordinates visualization of network traffic. The parallel coordinates visualization may include multiple vertical axes representing various metadata attributes associated with network flows. The network flows are presented as lines intersecting the various axes at points representing the values for the metadata attributes. As each network flow is represented by a single thin line, a large number of network flows can be represented on a single interface. By presenting data in this manner, a network owner may be able to identify network flows having metadata attribute values that are outliers from the majority of network flows, and thus identify network problems. The network owner may also be able to identify traffic patterns on the network by observing the shapes formed by the lines representing the network flows. For example, a large number of network flows diverging to a single point on a destination IP axis may indicate a denial of service attack. In another example, a large number of network flows from a single source IP intersecting many distinct points on a destination port axis may indicate a port scan being run by the computer at that source IP.

The parallel coordinates visualization may also be updated to include different axes based on the detected protocols used by the network flows. For example, the parallel coordinates visualization may be updated to include a user agent axis when network flows are detected using the Hypertext Transfer Protocol (HTTP). In another example, the parallel coordinates visualization may be updated to include a username axis in a filename axis when network flows of detected using the File Transfer Protocol (FTP). This dynamic updating of the parallel coordinates visualization allows for the network owner to be presented with a visualization specific to the traffic currently running on the network, or specific to the type of traffic the network owner is currently analyzing.

The present solution may provide several potential advantages. Allowing a network owner or administrator to review and analyze a large amount of network data at once may enable faster recognition and resolution of network problems. Further, dynamically updating the parallel coordinates visualization to include axes specific to the type of traffic being analyzed may further aid the recognition of network problems. The techniques described herein may also lead to faster anomaly detection based on protocol attributes in an environment by finding flow outliers (e.g., flows with application attributes different from the majority).

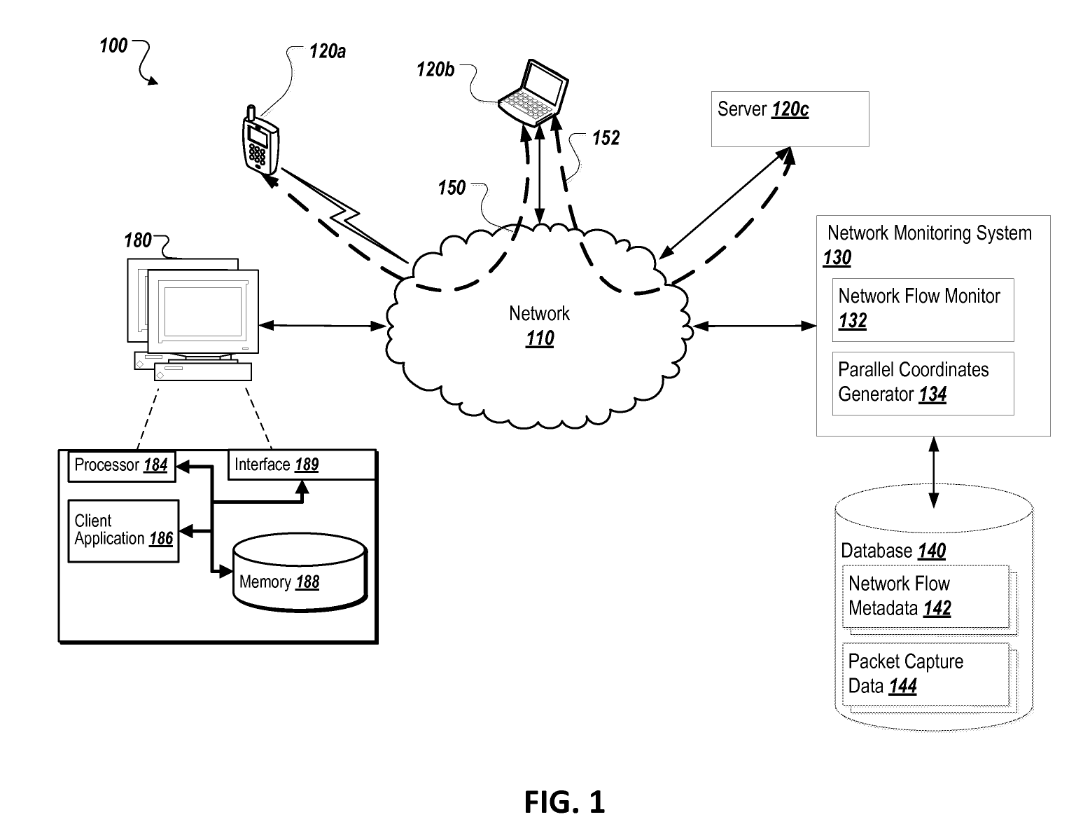

FIG. 1 shows an example environment 100 for enabling dynamic parallel coordinates visualization of network flows. The example environment 100 includes a plurality of devices 120a-c connected to a network 110. A network monitoring system 130 is also connected to the network 110. The network monitoring system 130 is connected to the database 140 including network flow metadata 142 associated with various observed network flows on the network 110, and packet capture data 144 representing packets captured during operation of the network monitoring system 130. The example environment 100 also includes one or more network flows 150, 152 that represent network communication between the one or more devices 120a-c over the network 110.

In operation, the network monitoring system 130 detects and analyzes network flows occurring on the network 110, such as the illustrated network flows 150 and 152. The network monitoring system analyzes the network flows to determine metadata attributes associated with the network flows 150, 152. The network monitoring system 130 then produces a parallel coordinates visualization illustrating the metadata attributes of the network flows 150, 152. In some implementations, the parallel coordinates visualization may include a plurality of axes, each axis being associated with one metadata attribute. The network flows 150, 152 are represented as lines in the parallel coordinates visualization connecting the various axes. The points at which the lines representing the network flows 150, 152 intersect the one or more axes indicate the values of the metadata attributes associated with each axis. The network monitoring system 130 may present the parallel coordinates visualization to a client 180 for viewing by a network administrator. The network administrator may use the parallel coordinates visualization to identify patterns occurring across the one or more network flows 150, 152, and to identify outlier values for the metadata attributes that may indicate problems on the network.

As shown, the environment 100 includes devices 120a-c. The environment 100 also includes one or more devices 120a-c connected to internal network 110. In some implementations, the one or more devices 120a-c include mobile devices, such as cellular telephones (e.g., 120a), smartphones, tablets, laptops (e.g., 120b) and other similar computing devices. The one or more devices 120a-c may also include wired devices such as desktop computers. In some implementations, the one or more devices 120a-c include personal devices associated with one or more users. The one or more devices 120a-c may also include devices issued or owned by the entity that provides the internal network 110, such as company-issued smartphones or laptops. In some implementations, the one or more devices 120a-c may run network access or web browsing software (e.g., a web browser) for accessing resources on the Internet 150. The one or more devices may also include servers connected to the internal network 110 (e.g., 120c).

As shown, the environment 100 includes an internal network 110. In some implementations, the internal network 110 may be a wireless or wired network provided by a corporation, educational institution, municipality, business, or other entity. Such a network may utilize any standard networking technology, including Ethernet, 802.11a, 802.11b, 802.11g, 802.11n, LTE, WiMax, CDMA, or any other suitable networking technology. In such implementations, the wireless network may be a public network in the sense that any device within range may connect to the network.

The environment 100 also includes a network flows 150, 152. In some implementations, the network flows 150, 152 represent a series of related packets or other information sent over the network 110 between the devices 120a-c. For example, the network flow 150 represents information sent over the network 110 between device 120a and device 120b, while the network flow 152 represents information sent over the network 110 between the device 120b and the server 120c. Network flows are discussed in greater detail below.

In the illustrated implementation, the environment 100 also includes a network monitoring system 130. In some implementations, the network monitoring system 130 may be a server or set of servers connected to the network 110 and configured to receive and analyze packets sent over the network 110. In some cases, the network monitoring system 130 may be a gateway between two networks included in the network 110, such that all packets sent from one network to the other pass through the network monitoring system 130. The network monitoring system 130 may also be deployed in a tap or span configuration, such that packets sent over the network 110 do not travel directly through the network monitoring system 130. Instead, in such a configuration, the network monitoring system 130 may receive a notification from another component in the network 110 informing it of packets sent on a network 110.

In some implementations, the network monitoring system 130 may be a computing device or a set of computing devices configured to perform the actions discussed above. In some cases, the network monitoring system 130 may be implemented as a combination of hardware and software. The network monitoring system 130 may also control or instruct other network components to perform any of the actions discussed herein.

In some cases, the network monitoring system 130 may also take as input file-based representations of packets, such as network trace information stored in packet capture (PCAP) format, and/or other formats. The network monitoring system 130 may also take as input data compiled or generated through the use of deep packet inspection techniques.

As shown, the network monitoring system 130 includes a network flow monitor 132. In operation, the network flow monitor 132 may receive the packets from the network 110 may classify the packets into various flows based on common attributes of the packets. For example, a first packet between device 120a and 120b on a port may be determined to be part of the same flow as a second packet between the device 120a and 120b on the same. The network flow monitor 132 may identify network flows as including the request and response pairs, such as an HTTP GET and an HTTP 200 OK response. In some implementations, the network flow monitor 132 may group packets associated with a user session as part of a single flow. For example, the network flow monitor 132 may identify packets including a particular session identifier as part of a network flow.

The network flow monitor 132 may also be operable to identify metadata attributes associated with the network flows 150, 152. In some implementations, the network flow monitor 132 may store the identified metadata attributes in the database 140 as network flow metadata 142. The network flow monitor 132 may analyze packets it is associated with the network flow, and extract information from the packets that is relevant to the network flow as a whole. For example, the network flow monitor 132 may extract a username and password from a login packet for a network flow. As all packets in the network flow may now be associated with this username and password, the network flow monitor 132 may store this information as a metadata attribute of the network flow. In another example, the network flow monitor 132 may extract user agent and URI attributes from a network flow utilizing the HTTP protocol, and may associate those attributes with the network flow.

In some implementations, the network flow monitor 132 (as well as other components of environment 100) may include functionality described in co-pending U.S. patent application No. ______, entitled “SELECTIVE PACKET CAPTURE,” filed ______, which is hereby incorporated by reference.

The network monitoring system 130 also includes a parallel coordinates generator 134. In operation, the parallel coordinates generator 134 may be operable to analyze the network flow data and metadata attributes produced by the network flow monitor 132, and produce a visual representation of the information. In some implementations, the parallel coordinates generator may produce a parallel coordinates diagram including one or more vertical axes. Each axis of the vertical axes may correspond to a metadata attribute. Each of the identified network flows 150, 152 may be plotted as a line intersecting each of the one or more virtual axes. The point at which the line intersects each of the one or more vertical axes may represent a value of the metadata attribute associated with the axis for the network flow associated with the line.

In some implementations, the parallel coordinates generator 134 may be operable to produce the parallel coordinates visualization in a visual data format, such as, for example, Adobe® Portable Document Format (PDF), Graphics Interchange Format (GIF), Joint Picture Experts Group (JPEG) format, Tagged Image File Format (TIFF), or any other suitable visual data format. The parallel coordinates generator 134 may also produce a data stream representing the parallel coordinates visualization that may be interpreted by another application (e.g., a client application 186) to produce a visual representation of the parallel coordinates visualization. The parallel coordinates generator may produce this data stream in any appropriate format, such as, for example, Extensible Markup Language (XML), JavaScript Object Notation (JSON), or any other appropriate format.

In the illustrated example, the network monitoring system 130 is connected to a database 140. In some implementations, the database 140 is stored on the same server as the network monitoring system 130. The database 140 may also be stored on a separate server and accessed by the network monitoring system 130 over a network, such as network 110. The database 140 may be any proprietary or commercially available database system or format, including, but not limited to, MySQL®, Microsoft® SQLServer, IBM® DB2, Oracle®, SQLite, or any other suitable database system or format. The database 140 may also be a distributed database running on a plurality of servers. In some implementations, the database 140 may be a configuration file or set of configuration files associated with the network monitoring system 130. The network monitoring system 130 may examine these configuration files to determine the currently configured rules and associated actions.

In the illustrated implementation, the database 140 includes network flow metadata 142. In some implementations, the network flow metadata 142 may include the one or more net metadata attributes identified by the network flow monitor 132 from the network flows 150, 152. The network flow metadata 142 may include a record store in a table or set of tables representing the metadata attributes study associated with the network flows 150, 152. For example, the network flow metadata 142 for a Structured Query Language (SQL) network flow may include a submitted SQL query, the database name the query was submitted against, login credentials associated with the flow, or any other suitable attributes associated with the network flow.

Database 140 may include packet capture data 144. In some cases, the network flow monitor 132 may initiate packet capture on particular network flows, and may store packet capture in the database 140 as packet capture data 144. In some implementations, the packet capture data 144 may be presented along with the parallel coordinates visualization produced by the parallel coordinates generator 134, such that when a network administrator activates a certain network flow (such as by clicking on it with a mouse) a portion of the packet capture data 144 associated with the network flow may be provided for inspection.

Illustrated client 180 is intended to encompass any computing device such as a desktop computer, laptop/notebook computer, wireless data port, smart phone, personal data assistant (PDA), tablet computing device, one or more processors within these devices, or any other suitable processing device. For example, client 180 may comprise a computer that includes an input device, such as a keypad, touch screen, or other device that can accept user information, and an output device that conveys information associated with the operation of the database system 130 or client 180 itself, including digital data, visual information, or a graphical user interface (GUI). Client 180 may include an interface 189, a processor 184, and a memory 188.

As shown, the client 180 also includes a client application 186. In some implementations, the client application 186 may be a graphical application for viewing the parallel coordinates visualization. In some instances, the client application 186 may be a web browser, in the parallel coordinates visualization may be presented in the context of a webpage. The client application 186 may also be a custom application designed to display the parallel coordinates visualization. In some implementations, the network monitoring system 130 may communicate parameters of the parallel coordinates visualization to the client application 186, and a client application 186 may render the parallel coordinates visualization for viewing. The client application 186 may also query the network monitoring system 130 for network flow information, and may render the parallel coordinates visualization according to the network flow information. The client application 186 may also be an image viewing application, and the network monitoring system 130 may provide an image or series of images of the parallel coordinates visualization for displaying the client application 186.

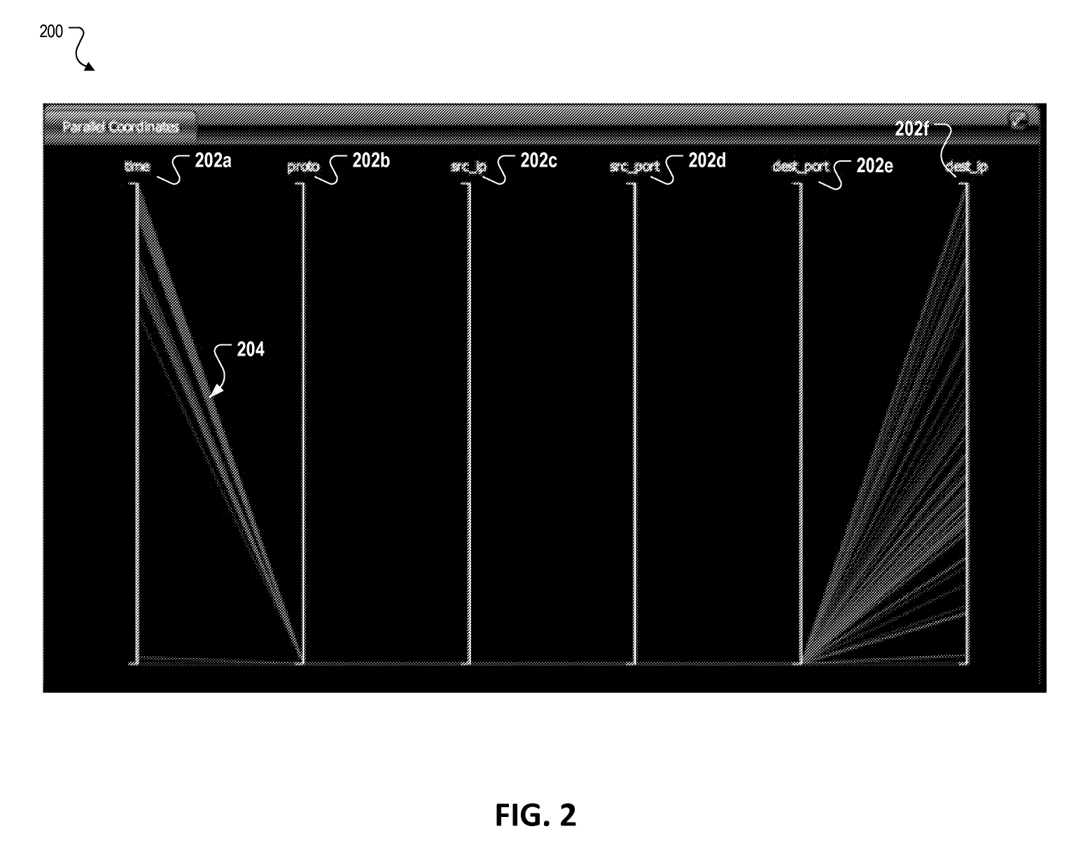

FIG. 2 is an example interface 200 showing a parallel coordinates visualization of a plurality of network flows.

The interface 200 includes a plurality of axes 202a-f. As shown, the axes 202a-f extend vertically across the interface 200. In the illustrated implementation, the axes 202a-f represent a set of metadata attributes associated with Internet Protocol (IP) network flows, including the time of the network flow, the protocol used for the network flow, the source IP address for the network flow, the source port for the network flow, the destination IP address for the network flow, and the destination port for the network flow. The interface 200 also includes a plurality of network flows 204. As shown, the network flows are represented by horizontal lines intersecting the one or more axes 202a-f.

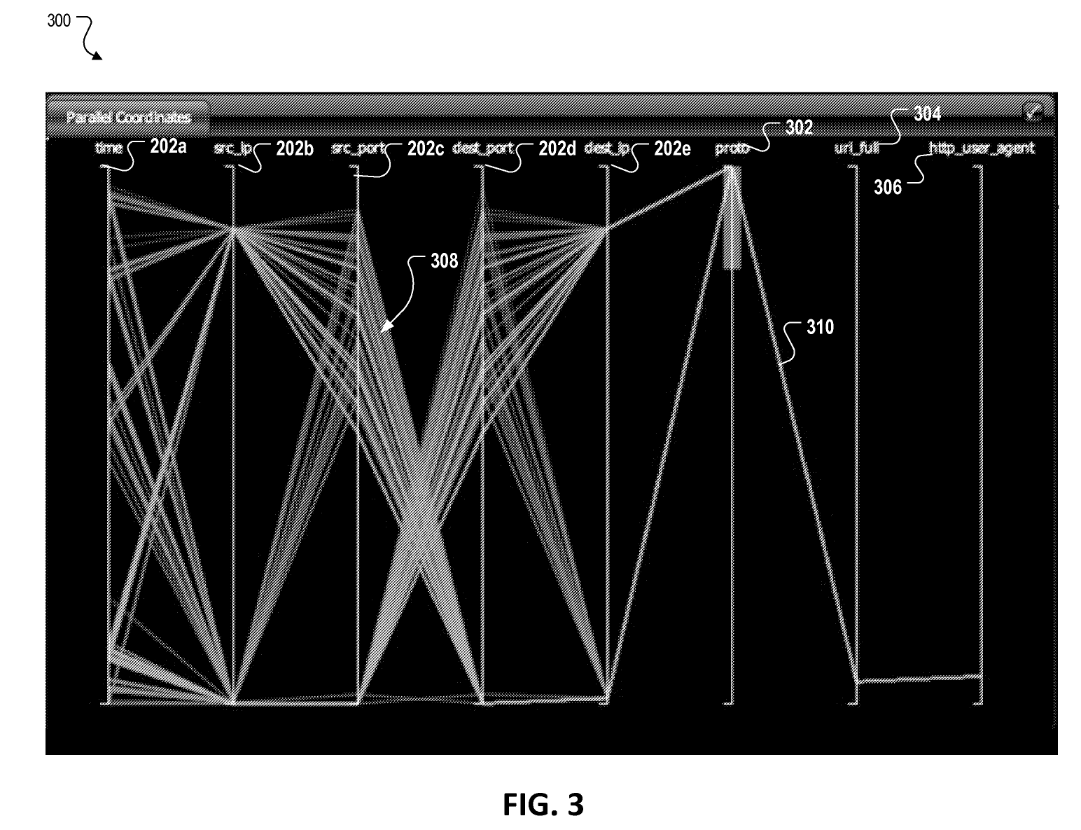

FIG. 3 is an example interface 300 showing a parallel coordinates visualization of a plurality of network flows including additional protocol-specific axes. The interface 300 includes the plurality of axes 202a-f previously described relative to FIG. 2.

The interface 300 also includes additional axes specific to the Hypertext Transfer Protocol (HTTP). Axis 304 represents the “uri_full” metadata attribute for an HTTP network flow, which indicates a resource accessed by the network flow. Axis 306 represents the “http_user_agent” metadata attribute for an HTTP network flow, which indicates the type of browser or program being used for the network flow.

The interface 300 also includes a plurality of network flows 308 that are plotted between the plurality of axes 202a-f. The interface 300 also includes additional network flows 310 that are plotted not only between the plurality of axes 2028 US, but also between the HTTP-specific axes 304 and 306. In some implementations, the network flows 310 may be presented in a manner visually distinct from the network flows 308, such as in a different color.

The HTTP specific axes 304 and 306 may be included in the interface 300 based on an analysis of the network flows 308 and 310. For example, if the uri_full metadata attribute is detected in one of the plurality of network flows 308, 310, the interface 300 may be updated to include the axis 304 corresponding to the uri_full metadata attribute. In some implementations, if the network flow is detected using a particular protocol, the set of axes associated with that protocol may be added to the interface 300.

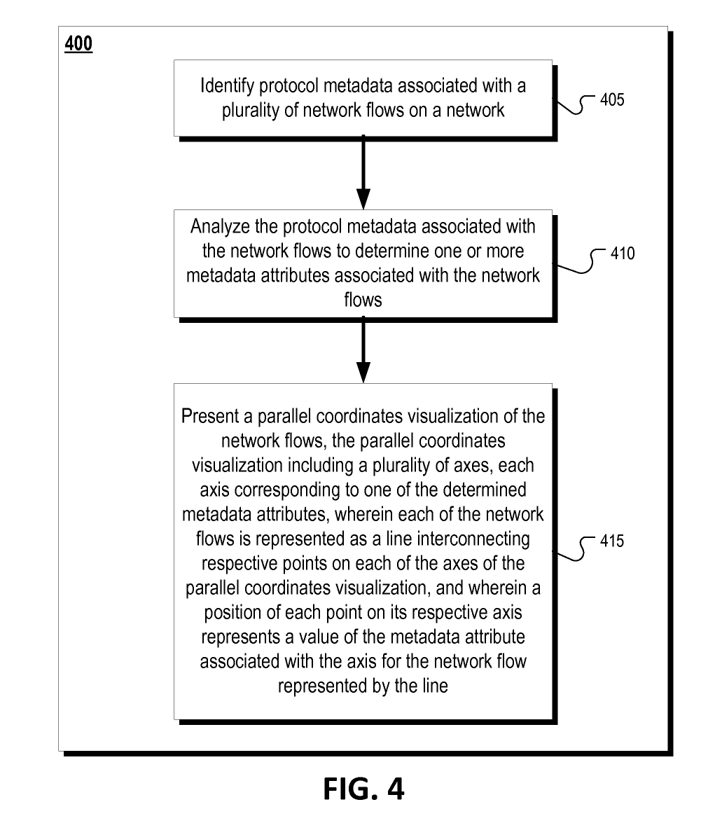

FIG. 4 is a flowchart of an example method for enabling dynamic parallel coordinates visualization of network flows. At 405, protocol metadata associated with one or more network flows on a network is identified. At 410, the protocol metadata associated with the one or more network flows is analyzed to determine one or more metadata attributes associated with the one or more network flows. In some implementations, the protocol metadata may be identified and analyzed by the network flow monitor 132 as described relative to FIG. 1.

At 415, a parallel coordinates visualization of the one or more network flows is present, the parallel coordinates visualization including one or more axes, each axis of the one or more axes associated with one or more metadata attributes, wherein each of the one or more network flows is represented as a line traversing a set of points on the axes of the parallel coordinates visualization, and a position on an axis of each point in the set of points represents a value for the metadata attributes associated with the axis for the network flow represented by the line. In some implementations, the parallel coordinates visualization may be produced by the parallel coordinates generator 134, as described relative to FIG. 1.

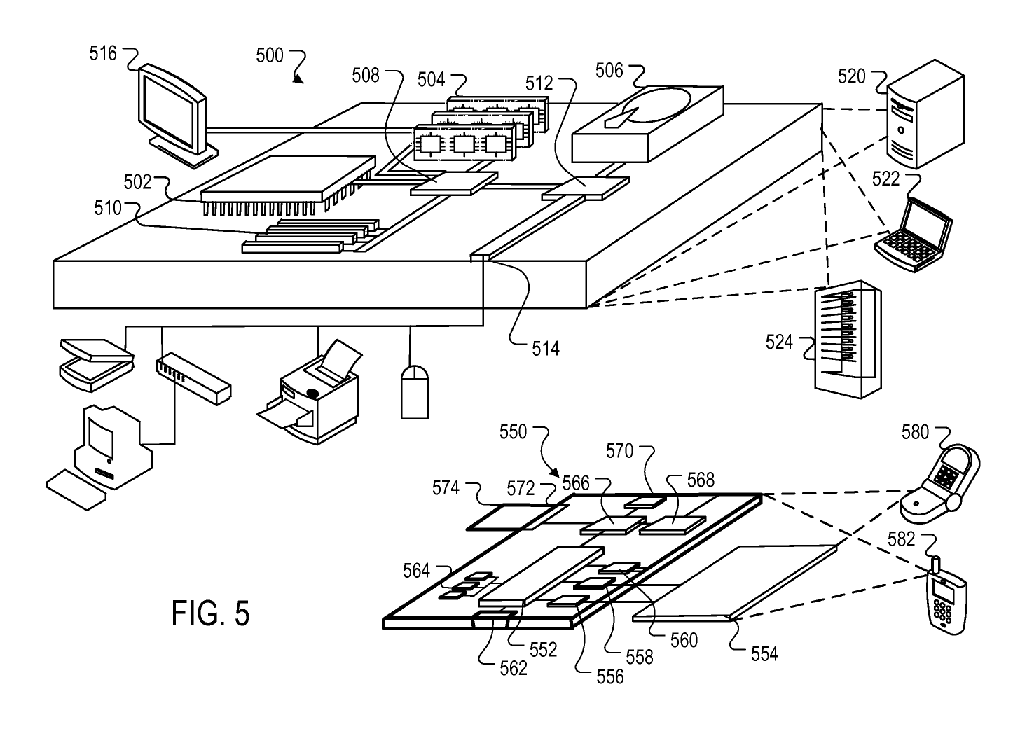

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user, as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front-end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method executed by one or more processors, the method comprising:
identifying protocol metadata associated with a plurality of network flows on a network;
analyzing the protocol metadata associated with the network flows to determine one or more metadata attributes associated with the network flows;
presenting a parallel coordinates visualization of the network flows, the parallel coordinates visualization including a plurality of axes, each axis corresponding to one of the determined metadata attributes, wherein each of the network flows is represented as a line interconnecting respective points on each of the axes of the parallel coordinates visualization, and wherein a position of each point on its respective axis represents a value of the metadata attribute associated with the axis for the network flow represented by the line.

2. The method of claim 1, wherein each of the network flows is associated with a protocol.

3. The method of claim 2, wherein a first line associated with a network flow associated with a first protocol is visually distinct from a second line associated with a network flow associated with a second protocol different than the first protocol.

4. The method of claim 3, wherein the first line is represented in a first color and the second line is represented in a second color different than the first color.

5. The method of claim 2, wherein the protocol is HyperText Transfer Protocol (HTTP) and analyzing the protocol metadata associated with the network flows includes determining one or more metadata attributes including at least one of: a user agent, a Uniform Resource Identifier (URI) of a resource accessed by the network flow, HTTP authentication credentials, or a referrer.

6. The method of claim 5, wherein presenting a parallel coordinates visualization of the network flows includes presenting at least one of: a user agent axis, a URI axis, an HTTP authentication credentials access, or a referrer axis.

7. The method of claim 2, wherein the protocol is Session Initiation Protocol (SIP) and analyzing the protocol metadata associated with the network flows includes determining one or more metadata attributes including at least one of: a caller, a callee, a user agent, a registrar, a via parameter, or a codec.

8. The method of claim 7, wherein presenting a parallel coordinates visualization of the network flows includes presenting at least one of: a callee axis, a caller axis, a user agent axis, registrar axis, a via parameter axis, or a codec axis.

9. The method of claim 2, wherein the protocol an application layer protocol.

10. The method of claim 1, further comprising:
modifying the parallel coordinates visualization to include an additional axis in response to determining a new metadata attribute associated with the one or more network flows, the additional axis associated with the new metadata attribute.

11. A system comprising:
a processor configured to execute computer program instructions; and
a computer storage medium encoded with computer program instructions that, when executed by the processor, cause the system to perform operations comprising:
identifying protocol metadata associated with a plurality of network flows on a network;
analyzing the protocol metadata associated with the network flows to determine one or more metadata attributes associated with the network flows;
presenting a parallel coordinates visualization of the network flows, the parallel coordinates visualization including a plurality of axes, each axis corresponding to one of the determined metadata attributes, wherein each of the network flows is represented as a line interconnecting respective points on each of the axes of the parallel coordinates visualization, and wherein a position of each point on its respective axis represents a value of the metadata attribute associated with the axis for the network flow represented by the line.

12. The system of claim 11, wherein each of the network flows is associated with a protocol.

13. The system of claim 12, wherein a first line associated with a network flow associated with a first protocol is visually distinct from a second line associated with a network flow associated with a second protocol different than the first protocol.

14. The system of claim 13, wherein the first line is represented in a first color and the second line is represented in a second color different than the first color.

15. The system of claim 12, wherein the protocol is HyperText Transfer Protocol (HTTP) and analyzing the protocol metadata associated with the network flows includes determining one or more metadata attributes including at least one of: a user agent, a Uniform Resource Identifier (URI) of a resource accessed by the network flow, HTTP authentication credentials, or a referrer.

16. The system of claim 15, wherein presenting a parallel coordinates visualization of the network flows includes presenting at least one of: a user agent axis, a URI axis, an HTTP authentication credentials access, or a referrer axis.

17. The system of claim 12, wherein the protocol is Session Initiation Protocol (SIP) and analyzing the protocol metadata associated with the network flows includes determining one or more metadata attributes including at least one of: a caller, a callee, a user agent, a registrar, a via parameter, or a codec.

18. The system of claim 17, wherein presenting a parallel coordinates visualization of the network flows includes presenting at least one of: a callee axis, a caller axis, a user agent axis, registrar axis, a via parameter axis, or a codec axis.

19. The system of claim 12, wherein the protocol an application layer protocol.

20. The system of claim 11, the operations further comprising:
modifying the parallel coordinates visualization to include an additional axis in response to determining a new metadata attribute associated with the one or more network flows, the additional axis associated with the new metadata attribute.
